(19) United States
(12) Patent Application Publication
(10) Pub. No.: US 2026/0197278 A1
(43) Pub. Date: Jul. 9, 2026

(54) METHOD FOR RESOLVING NETWORK FUNCTION (NF) ABNORMAL CONDITIONS, NETWORK ENTITY, AND MANAGEMENT DATA ANALYTICS (MDA)

(71) Applicant: GUANGDONG OPPO MOBILE TELECOMMUNICATIONS CORP., LTD., Dongguan (CN)

(72) Inventor: Alla GOLDNER, Tel Aviv (IL)

(73) Assignee: GUANGDONG OPPO MOBILE TELECOMMUNICATIONS CORP., LTD., Dongguan (CN)

(21) Appl. No.: 19/558,209

(22) Filed: Mar. 5, 2026

Related U.S. Application Data
(63) Continuation of application No. PCT/CN2024/076751, filed on Feb. 7, 2024.

(51) Int. Cl. H04L 47/12; H04L 43/0876

(52) U.S. Cl. CPC H04L 47/12; H04L 43/0876

(57) ABSTRACT

A method for resolving Network Function (NF) abnormal conditions is provided. The method is performed by a network entity and includes that: NF abnormal behavior/functionality analysis data is received from Management Data Analytics (MDA); and an action is performed based on the NF abnormal behavior/functionality analysis data. A network entity and a Management Data Analytics (MDA) are also provided. This can improve the efficiency for handling NF abnormal behavior/functionality.

### CROSS REFERENCE TO RELATED APPLICATION

The present application is a continuation of International Application No. PCT/CN2024/076751, filed on Feb. 7, 2024, and the entire content thereof is incorporated herein by reference.

### TECHNICAL FIELD

The present application relates to wireless communication, and more particularly, to a method of resolving Network Function (NF) abnormal conditions, and related devices.

### BACKGROUND

With the arrival of 5th-generation (5G) communication systems, a huge increase in the number of connected devices is expected. These connected devices, like cars, robots, drones, home gadgets, screens, and smart sensors, will mostly connect to networks. Even things like factory equipments will likely join in. To handle the huge number of devices in the future 6th-generation (6G) era, considerable efforts are being dedicated to enhancing 6G communication systems.

Signaling storm experienced by the 5G system (5GS) core network functions is one of the major problems Service Providers are facing while deploying their 5GS. As a result of signaling storm experienced by the core network functions, the corresponding Network Function (NF) behavior/functionality might be badly affected, as well as the functionality of the Network Function(s) it communicates with. Several Service Providers expressed their high interest in studying the topic and resolving this issue as a part of 3GPP SA WG2 R-19 standardization.

Currently, in pre-R19 standardization, only Operations, Administration, and Maintenance (OAM) based solutions could have place, that is, OAM detects the signaling storm and applies corresponding OAM action, e.g. scaling of the corresponding Network Function, instantiating a new entity of the Network Function etc.

The 3GPP documents which define the existing technology in misbehavior use case are TS.23.288 and TS 28.104. TS 23.288 defines architecture enhancements for 5G System (5GS) to support network data analytics services e.g. how Network Data Analytics Function (NWDAF), by gathering and distributing analytics (statistics and predictions) information can assist 5GS to detect, predict and mitigate a different 5GS misbehavior use case. TS 28.104 defines Management Data Analytics (MDA) e.g. how management data analytics are gathered and distributed in order to detect, predict and mitigate a different misbehavior use case on the OAM layer. As also defined by TS 23.288 and TS 28.104, as a part of existing functionality, MDA and NWDAF have interface which allows them to communicate the corresponding information with each other. There is also an existing art, S5-240799—the Change Request (CR) under discussion by 3GPP SA WG5. The contents related to congestion (SA WG5 terminology for issuing such a signaling storm) are approved already and expected to get into TS 28.104.

As defined by the S5-240799, for the 3GPP R-18 functionality, MDA will be able to get signaling storm/related congestion information (e.g., performance measurements, alarm notifications, configuration data) at least for Session Management Function (SMF) and Access and Mobility Management Function (AMF). Based on those sets of the information, MDA will be able to create analytics output including e.g. the affected object (e.g. corresponding Network Function) and Congestion Issue Identifier. As also defined within the scope of TS 28.104, NWDAF may become a consumer of such analytics information provided by MDA, in case NWDAF subscribes to such analytics information. The procedure of how NWDAF subscribes for the analytics information available at MDA is defined by the TS 23.288.

### SUMMARY

In a first aspect, some embodiments of the present application provide a method of resolving Network Function (NF) abnormal conditions, performed by a network entity, including receiving NF abnormal behavior/functionality analysis data from a Management Data Analytics (MDA); and performing an action based on the received NF abnormal behavior/functionality analysis data.

In a second aspect, some embodiments of the present application provide a network entity, including: at least one memory configured to store program instructions; and at least one processor configured to execute the program instructions, which cause the at least one processor to receive NF abnormal behavior/functionality analysis data from a Management Data Analytics (MDA); and perform an action based on the received NF abnormal behavior/functionality analysis data.

In a third aspect, some embodiments of the present application provide a Management Data Analytics (MDA), including: at least one memory configured to store program instructions; and at least one processor configured to execute the program instructions, which cause the at least one processor to transmit Network Function (NF) abnormal behavior/functionality analysis data to a network entity, such that the network entity performs an action based on the NF abnormal behavior/functionality analysis data.

### BRIEF DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic diagram of an architecture of a communication system according to an embodiment of the disclosure.

FIG. 2 is a schematic diagram of a 5th-Generation (5G) architecture according to an embodiment of the disclosure.

FIG. 3 is a block diagram of an operation of network data analytics function (NWDAF) according to an embodiment of the present application.

FIG. 4 is a flowchart of a method of resolving Network Function (NF) abnormal conditions according to an embodiment of the present application.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present application are merely for describing the purpose of the certain embodiment, but not to limit the disclosure.

In this document, a combination such as “at least one of A, B, or C,” “one or more of A, B, or C,” “at least one of A, B, and C,” “one or more of A, B, and C,” or “A, B, and/or C” may be A only, B only, C only, A and B, A and C, B and C, or A and B and C, where any combination may contain one or more members of A, B, or C.

This invention proposes, on top of existing OAM actions, based on the indications, received from OAM into the core network, to introduce also 5GS/core network related functions, which might be more efficient and provide a longer term solution for signaling storm handling.

Additional NF abnormal behaviors, detected by OAM, might be handled in the very similar way. Signaling storm is the most demanded one, however, and the one requested by Service Providers to be handled in R-19.

It is also expected that in 6G distributed analytics mechanisms will be defined, and Network Functions would also get a similar information about signaling storm from the management layer (not necessarily split into MDA, as opposed to NWDAF, handling the core network analytics).

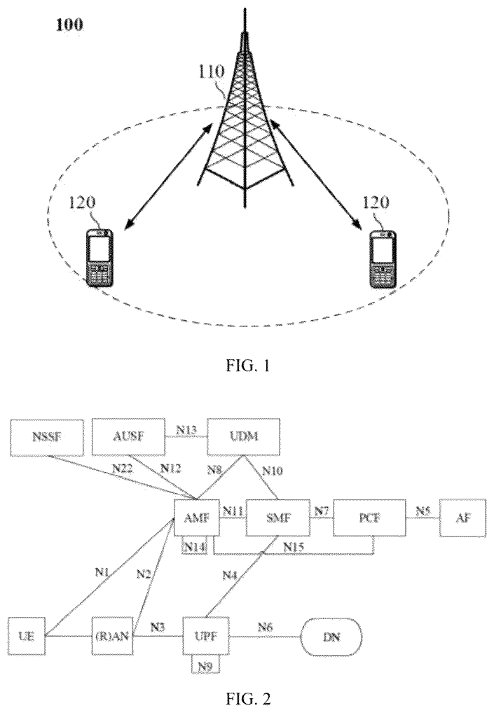

Exemplarily, FIG. 1 shows a communication system 100 that the embodiments of the disclosure are applied to. The communication system 100 may include a network device 110. The network device 110 may be a device that communicates with a terminal 120 (or referred to as a communication terminal and a terminal). The network device 110 may provide communication coverage for a specific geographical region and communicate with a terminal within the coverage. Optionally, the network device 110 may be an Evolutional Node B (eNB or eNodeB) in the LTE system, or a wireless controller in a Cloud Radio Access Network (GRAN). Alternatively, the network device may be a mobile switching center, a relay station, an access point, an onboard device, a wearable device, a hub, a switch, a network bridge, a router, a network-side device in the 5G network, a network device in a future communication system, or the like.

The communication system 100 further includes at least one terminal 120 within the coverage of the network device 110. The “terminal” used herein includes, but not limited to, a device configured to receive/send a communication signal through a wired line connection, for example, through Public Switched Telephone Network (PSTN), Digital Subscriber Line (DSL), digital cable and direct cable connections, and/or another data connection/network) and/or through a wireless interface, for example, for a cellular network, a Wireless Local Area Network (WLAN), a digital television network like a Digital Video Broadcasting-Handheld (DVB-H) network, a satellite network and an Amplitude Modulated (AM)-Frequency Modulated (FM) broadcast transmitter, and/or another terminal, and/or an Internet of Things (IoT) device. The terminal configured to communicate through a wireless interface may be referred to as a “wireless communication terminal”, a “wireless terminal”, or a “mobile terminal.” Examples of the mobile terminal include, but not limited to, a satellite or cellular telephone, a Personal Communication System (PCS) terminal capable of combining a cellular radio telephone and data processing, faxing, and data communication capabilities, a Personal Digital Assistant (PDA) capable of including a radio telephone, a pager, Internet/intranet access, a Web browser, a notepad, a calendar, and/or a Global Positioning System (GPS) receiver, and a conventional laptop and/or palmtop receiver or another electronic device including a radio telephone transceiver. The terminal may be an access terminal, UE, a user unit, a user station, a mobile station, a mobile radio station, a remote station, a remote terminal, a mobile device, a user terminal, a terminal, a wireless communication device, a user agent, or a user device. The access terminal may be a cell phone, a cordless phone, a Session Initiation Protocol (SIP) phone, a Wireless Local Loop (WLL) station, a PDA, a handheld device with a wireless communication function, a computing device, another processing device connected to a wireless modern, a vehicle device, a wearable device, a terminal in the 5G network, a terminal in the future evolved PLMN, or the like.

One network device and two terminals are exemplarily shown in FIG. 1. Optionally, the communication system 100 may include multiple network devices, and there may be included another number of terminals in coverage of each network device. No limits are made thereto in the embodiments of the disclosure.

The communication system 100 may further include another network entity, such as a network controller and a mobility management entity. No limits are made thereto in the embodiments of the disclosure.

FIG. 2 shows a 5G architecture. Devices involved in the 5G architecture include: UE, a RAN, a User Plane Function (UPF), a Data Network (DN), an Access and Mobility Management Function (AMF), an SMF, a PCF, an Application Function (AF), an Authentication Server Function (AUSF), and Unified Data Management (UDM).

As shown in FIG. 2, policy related network elements mainly include the PCF, the AMF, the SMF, the RAN, and the UE. The SMF is mainly responsible for executing session related policies. The AMF is mainly responsible for executing access and UE policy related policies. Policy transmission and update of the two network elements (the AMF and the SMF) are managed and controlled by the PCF.

Specific to a UE policy, information about the UE policy, including a content of the UE policy, an Identifier (ID) of the UE policy, etc., is monitored between the PCF and the UE through a container. In an uplink direction, the container is sent to the AMF by the UE through a Non Access Stratum (NAS) message, and continues to be transparently transmitted (without perception or modification) to the PCF by the AMF. Reversely, in a downlink direction, the container is sent to the AMF by the PCF, and is further transparently transmitted to the UE by the AMF through a NAS message.

FIG. 3 is a block diagram of an operation of network data analytics function (NWDAF) according to an embodiment of the present application. Referring to FIG. 3, a network entity (e.g., NWDAF, AMF, SMF) requests or receives NF abnormal behavior/functionality analysis data from Operations, Administration, and Maintenance (OAM) and perform a corresponding action based on the received analysis data.

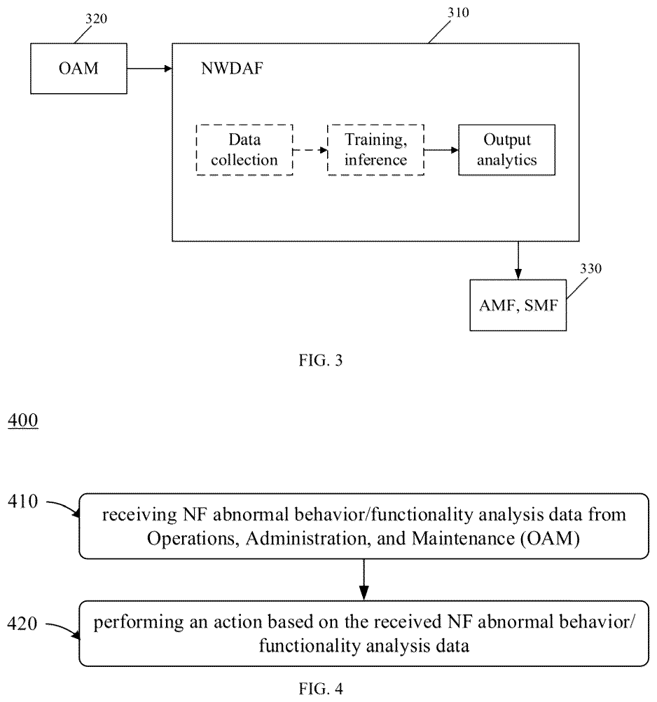

FIG. 4 is a flowchart of a method of resolving Network Function (NF) abnormal conditions according to an embodiment of the present application. Referring to FIG. 3 and FIG. 4, the method 400 is performed by a network entity (e.g., NWDAF, AMF, SMF) and includes the followings. In Step 410, the network entity receives NF abnormal behavior/functionality analysis data from OAM. In Step S420, the network entity performing an action based on the received NF abnormal behavior/functionality analysis data. This can improve the efficiency and provide a longer term solution for handling NF abnormal behavior/functionality.

In some embodiments, NF abnormal behavior/functionality analysis data includes storm/congestion analysis data. In some embodiments, the storm/congestion analysis data includes at least one of an affected NF or a congestion issue identifier. In some embodiments, the action includes adjusting a back-off timer. In some embodiments, the action includes at least one of the following: changing periodicity of usage monitoring data reports; or changing periodicity of reports between the network entity and another network entity. In some embodiments, the network entity is Network Data Analytics Function (NWDAF). In some embodiments, OAM analytics collection is performed by Management Data Analytics (MDA), and the NWDAF receives the NF abnormal behavior/functionality analysis data from the MDA. In some embodiments, the action includes notifying another network entity. In some embodiments, the network entity performing the method is Access and Mobility Management Function (AMF) or Session Management Function (SMF).

Similar to how input data analytics is received from OAM for observed service experience (TS 23.288), the signaling storm/congestion analysis data would be received by NWDAF. The set of data will include the set of data created by MDA for congestion analysis/signaling storm i. e as of the TS 28.104, including e.g. the affected object (e.g. corresponding Network Function) and congestion issue identifier.

This is how e.g. NWDAF would become aware of the issues detected and predicted by MDA (on the management layer) related to signaling storm.

Those newly defined analytics would be available for subscription by a different Network Functions of the core network. For 5GS R-19 , SMF and AMF would subscribe for such Signaling Storm information. In the future releases and in 6G, more Network Functions would be able to get management layer congestion related/signaling storm related data.

As per exposure procedures, NWDAF would notify e.g. AMF or SMF of the related detected/or predicted signaling storm. The AMF or SMF would be able to apply e.g. mitigation actions on the core network layer (e.g. increase or adjust back-off timer by AMF, change of e.g. usage monitoring data reports periodicity/charging reports periodicity between SMF and PCF and SMF and CHF correspondingly etc). This would eventually assist in releasing signaling storm by the 5GS.

The invention introduces new parameters passed from OAM into core network functions (via NWDAF), related to the signaling storm of the corresponding Network Functions, detected with the assistance of OAM.
NWDAF may subscribe for the corresponding information reception from OAM.
A different 5GS Network Functions (e.g. AMF, SMF, etc.) can subscribe for getting such information/information updates then.

Based on the received analytics information, the specific Network Function can make a more sophisticated decision related to its functionality e.g. AMF can change the back-off timer etc., and thus improve the 5GS behavior by releasing the signaling storm.

As Service Providers report on facing signaling storms in their 5GS, it is extremely important to provide and deploy means by which such a signaling storm can be detected, predicted and mitigated. This would improve operability of the 5G networks. OAM has already some solutions to address this issue, however those solutions:
1. might be too expensive (e.g. scaling or deploying a new instance of the corresponding Network Function)
2. might take a long time to mitigate the problem.

Therefore, the proposed solution, which adds 5GS signaling storm handling, on top of OAM handling, might significantly improve 5GS operability without increasing the network costs.

Those of ordinary skill in the art may realize that the units and algorithm steps of each example described in combination with the embodiments disclosed herein may be implemented by electronic hardware or a combination of computer software and electronic hardware. Whether these functions are performed by hardware or software depends on specific applications and design constraints of the technical solutions. Professionals may realize the described functions for each specific application by use of different methods, but such realization shall fall within the scope of the disclosure.

Those skilled in the art may clearly know that for specific working processes of the system, device and unit described above, reference can be made to the corresponding processes in the method embodiment, and they will not be elaborated herein for ease and brevity of description.

In some embodiments provided in the disclosure, it is to be understood that the disclosed system, apparatus, and method may be implemented in manners. For example, the apparatus embodiment described above is only schematic. For example, division of the units is only logic function division, and other division manners may be used during practical implementation. For example, multiple units or components may be combined or integrated into another system, or some characteristics may be neglected or not performed. In addition, coupling or direct coupling or communication connection between each displayed or discussed component may be indirect coupling or communication connection, implemented through some interfaces, of the apparatus or the units, and may be electrical and mechanical or adopt other forms.

The units described as separate parts may or may not be physically separated. Parts displayed as units may or may not be physical units, namely they may be located in the same place, or may be distributed to multiple network units. Part or all of the units may be selected to achieve the objectives of the solutions of the embodiments as practically needed.

In addition, each function unit in each embodiment of the disclosure may be integrated into a processing unit. Alternatively, each unit may physically exist independently. Alternatively, two or more than two units may be integrated into a unit.

When being realized in form of a software function unit and sold or used as an independent product, the function may also be stored in a computer-readable storage medium. Based on such an understanding, the technical solutions of the disclosure substantially or parts making contributions to the conventional art or part of the technical solutions may be embodied in form of a software product. The computer software product is stored in a storage medium, including a plurality of instructions for enabling a computer device (which may be a personal computer, a server, a network device, or the like) to execute all or part of the steps of the method in each embodiment of the disclosure. The above-mentioned storage medium includes various media capable of storing program codes, such as a U disk, a mobile hard disk, a ROM, a RAM, a magnetic disk, or an optical disk.

The above is only the specific implementation mode of the disclosure and not intended to limit the scope of protection of the disclosure. Any variations or replacements apparent to those skilled in the art within the technical scope disclosed in the disclosure shall fall within the scope of protection of the disclosure. Therefore, the scope of protection of the disclosure shall be subject to the scope of protection of the claims.

1. A method for resolving Network Function (NF) abnormal conditions, performed by a network entity, comprising:
receiving NF abnormal behavior/functionality analysis data from Management Data Analytics (MDA); and
performing an action based on the NF abnormal behavior/functionality analysis data.

2. The method of claim 1, wherein the NF abnormal behavior/functionality analysis data comprises signaling storm/congestion analysis data.

3. The method of claim 2, wherein the signaling storm/congestion analysis data comprises at least one of an affected NF or a congestion issue identifier.

4. The method of claim 1, wherein the action comprises adjusting a back-off timer.

5. The method of claim 1, wherein the action comprises at least one of the following:
changing periodicity of usage monitoring data reports; or
changing periodicity of reports between the network entity and another network entity.

6. The method of claim 1, wherein the network entity is Network Data Analytics Function (NWDAF).

7. The method of claim 6, wherein the action comprises notifying another network entity.

8. The method of claim 7, wherein notifying the another network entity comprises:
notifying an Access and Mobility Management Function (AMF) of a detected or predicted signaling storm, such that the AMF applies mitigation actions.

9. The method of claim 8, wherein mitigation actions comprise:
increasing or adjusting a back-off timer to mitigate a signaling storm.

10. A network entity, comprising:
at least one memory configured to store program instructions; and
at least one processor configured to execute the program instructions, which cause the at least one processor to:
receive NF abnormal behavior/functionality analysis data from Management Data Analytics (MDA); and
perform an action based on the NF abnormal behavior/functionality analysis data.

11. The network entity of claim 10, wherein the NF abnormal behavior/functionality analysis data comprises signaling storm/congestion analysis data.

12. The network entity of claim 11, wherein the signaling storm/congestion analysis data comprises at least one of an affected NF or a congestion issue identifier.

13. The network entity of claim 10, wherein the action comprises adjusting a back-off timer.

14. The network entity of claim 10, wherein the action comprises at least one of the following:
changing periodicity of usage monitoring data reports; or
changing periodicity of reports between the network entity and another network entity.

15. The network entity of claim 10, wherein the network entity is Network Data Analytics Function (NWDAF).

16. The network entity of claim 15, wherein the action comprises notifying another network entity.

17. The network entity of claim 16, wherein notifying the another network entity comprises:
notifying an Access and Mobility Management Function (AMF) of a detected or predicted signaling storm, such that the AMF applies mitigation actions.

18. The network entity of claim17, wherein mitigation actions comprise:
increasing or adjusting a back-off timer to mitigate a signaling storm.

19. A Management Data Analytics (MDA), comprising:
at least one memory configured to store program instructions; and
at least one processor configured to execute the program instructions, which cause the at least one processor to:
transmit Network Function (NF) abnormal behavior/functionality analysis data to a network entity, such that the network entity performs an action based on the NF abnormal behavior/functionality analysis data.

20. The MDA of claim 19, wherein the NF abnormal behavior/functionality analysis data comprises signaling storm/congestion analysis data.
